(19) United States
(12) Patent Application Publication
(10) Pub. No.: US 2018/0165133 A1
(43) Pub. Date: Jun. 14, 2018

(54) Shared Memory Using Memory Mapped Files Between Host And Guest On A Computing Device

(71) Applicant: Microsoft Technology Licensing, LLC, Redmond, WA (US)

(72) Inventors: Mehmet Iyigun, Kirkland, WA (US); Matthew David Kurjanowicz, North Bend, WA (US); Martijn de Kort, Mill Creek, WA (US); Kevin M. Broas, Kirkland, WA (US); Yevgeniy M. Bak, Redmond, WA (US)

(73) Assignee: Microsoft Technology Licensing, LLC, Redmond, WA (US)

(21) Appl. No.: 15/638,894

(22) Filed: Jun. 30, 2017

Related U.S. Application Data
(60) Provisional application No. 62/433,640, filed on Dec. 13, 2016.

(51) Int. Cl. G06F 9/50; G06F 9/455; G06F 12/1036; G06F 9/48; H04L 29/08; G06F 12/14

(52) U.S. Cl. CPC G06F 9/5077; G06F 9/45533; G06F 12/145; G06F 9/4856; H04L 67/1008; G06F 12/1036

(57) ABSTRACT

A computing device runs a host on which multiple guests (e.g., virtual machines run via a virtual machine monitor such as a hypervisor) can run. The guest is used for isolation as well as hardware resource partitioning. The guest and the host agree on a name and a size for shared memory. Both the guest and the host map to the shared memory, and both the guest and the host to access the shared memory. The access allowed to the shared memory can be the same for both the host and the guest (e.g., both may be allowed read/write access) or different (e.g., the guest may be allowed write only access and the host may be allowed read only access).

### Related Applications

This application claims priority to U.S. Provisional Application No. 62/433,640, filed Dec. 13, 2016, entitled “Shared Memory Between Host And Guest On A Computing Device”, the disclosure of which is hereby incorporated by reference herein in its entirety.

### BACKGROUND

Operating systems can use hardware resource partitioning to share hardware resources among multiple different virtual machines or containers. While such sharing can increase the security or isolation of different processes or virtual machines deployed on a device, such sharing is not without its problems. One such problem is that the communication of data between processes in different virtual machines or containers can be time-consuming, which can degrade the performance of the virtual machine or containers.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, a host on a computing device has an associated host memory and a guest on the computing device has an associated guest memory. An agreement is made by the host and the guest on a name and a size for a shared memory. An address space in the computing device to be the shared memory is identified, the address space having at least the agreed upon size. The address space is allocated or assigned to the shared memory, and an indication of the address space that is the shared memory is provided to the guest. The host communicates data to and/or receives data from the guest via the shared memory.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 illustrates an example system implementing the shared memory between host and guest on a computing device in accordance with one or more embodiments.

FIGS. 2 and 3 each illustrate multiple guests in accordance with one or more embodiments.

FIG. 4 is a flowchart illustrating an example process for implementing the shared memory between host and guest on a computing device in accordance with one or more embodiments.

FIG. 5 illustrates an example system that includes an example computing device that is representative of one or more systems and/or devices that may implement the various techniques described herein.

### DETAILED DESCRIPTION

Shared memory between host and guest on a computing device is discussed herein. A computing device runs a host on which multiple guests (e.g., virtual machines run via a virtual machine monitor such as a hypervisor) can run. The guest is used for isolation as well as hardware resource partitioning. Using the techniques discussed herein, the guest and the host agree on a name and a size for shared memory. Both the guest and the host map to the shared memory, allowing both the guest and the host to access the shared memory. The access allowed to the shared memory can be the same for both the host and the guest (e.g., both may be allowed read/write access) or different (e.g., the guest may be allowed write only access and the host may be allowed read only access).

The shared memory allows data to be quickly communicated between the host and the guest. Time need not be expended by the host or the guest copying data to be communicated between the host and the guest, marshaling data to be communicated between the host and the guest, and so forth.

The techniques discussed herein can be used in any of a variety of different situations in which a host and guest desire to communicate data between one another. For example, a guest can be used to run a Web browser, providing additional security by having the Web browser run isolated from other programs in the system. However, a window including the Web browser display can be displayed by the host. The techniques discussed herein allow the Web browser to store data to be displayed in the shared memory, then the host can display the data from the shared memory. No copying or marshaling of the data to be displayed between the guest and the host need be performed.

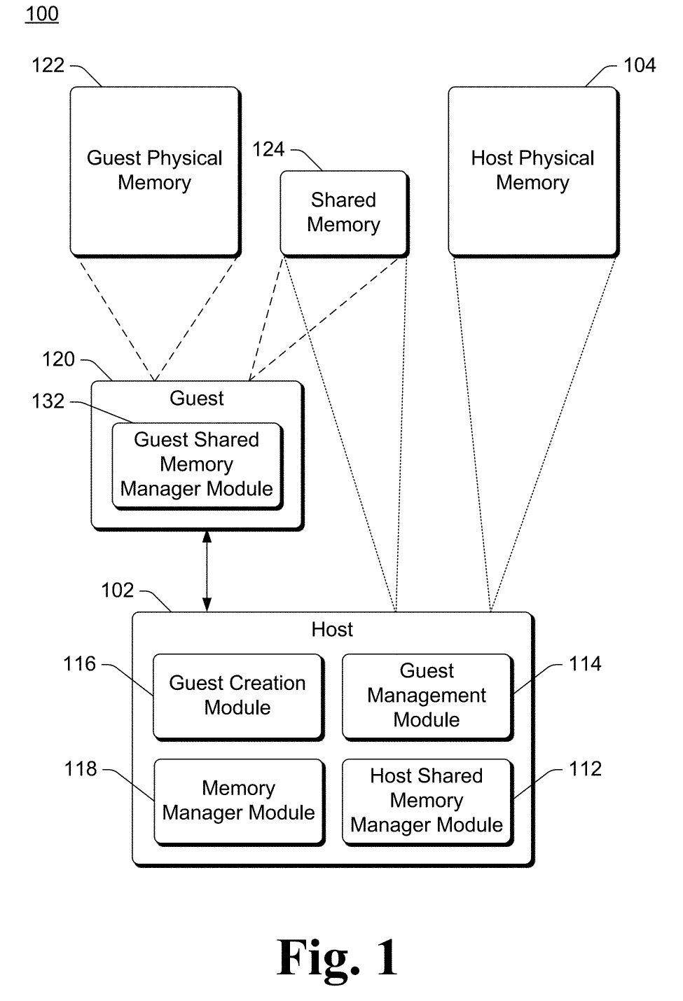

FIG. 1 illustrates an example system 100 implementing the shared memory between host and guest on a computing device in accordance with one or more embodiments. System 100 is implemented at least in part by a computing device. Any of a variety of different types of computing devices can be used to implement the system 100, such as a server computer, a desktop computer, a laptop or netbook computer, a mobile device (e.g., a tablet or phablet device, a cellular or other wireless phone (e.g., a smartphone), a notepad computer, a mobile station), a wearable device (e.g., eyeglasses, head-mounted display, watch, bracelet, virtual reality glasses or headset, augmented reality headset or glasses), an entertainment device (e.g., an entertainment appliance, a set-top box communicatively coupled to a display device, a game console), Internet of Things (IoT) devices (e.g., objects or things with software, firmware, and/or hardware to allow communication with other devices), a television or other display device, an automotive computer, and so forth. Thus, the computing device implementing system 100 may range from a full resource device with substantial memory and processor resources (e.g., personal computers, game consoles) to a low-resource device with limited memory and/or processing resources (e.g., traditional set-top boxes, hand-held game consoles).

The system 100 includes a host 102 and a host physical memory 104. In one or more embodiments, the host 102 and the host physical memory 104 are implemented as part of the same computing device. Alternatively, at least part of the host physical memory 104 can be implemented on a separate device from the device implementing the host 102. The host 102 can be, for example, a host operating system or a hypervisor.

The host 102 includes a host shared memory manager module 112, a guest management module 114, a guest creation module 116, and a memory manager module 118. The host 102 also manages one or more containers or virtual machines, illustrated as a guest 120. The guest creation module 116 creates a guest in any of a variety of manners, such as building or generating a guest from scratch, by “cloning” a guest template (which refers to copying the guest template into memory of the system 100 to create a new guest 120), and so forth. While the newly created guest 120 is running, the guest management module 116 manages the guest 120, for example determining when the guest 120 is to run (i.e., execute). The guest management module 114 also manages tear down or deletion of the guest 120 when the guest 120 is no longer needed or desired in the system 100.

The host shared memory manager module 112 facilitates sharing memory between the guest 120 and the host 102. When the host 102 is created in the system, the host physical memory 104 is allocated or assigned to the host 102. When the guest 120 is created, guest physical memory 122 is allocated or assigned to the guest 120. The guest physical memory 122 is referred to as “physical memory” because from the viewpoint of the guest 120 the guest physical memory 122 is physical memory. However, because the guest 120 is a virtualized component (e.g., a virtual machine or a container), the guest physical memory 122 is a virtualization of physical memory (e.g., the virtualization being unknown to the guest 120).

The system 100 also includes shared memory 124. Shared memory 124 refers to memory that is accessible to both the guest 120 and the host 102. Various access controls can be established on the shared memory 124, but at least some access to the shared memory 124 is permitted for both the guest 120 and the host 102. For example, the guest 120 can be permitted to write data to the shared memory 124 that can then be read by the host 102. It should be noted that, although illustrated as separate from the guest physical memory 122, the shared memory 124 can be a subset of (e.g., be part of) the guest physical memory 122.

Although a single guest 120 is illustrated in FIG. 1, multiple guests can be run in the system 100 concurrently, and each guest includes one or more components. These components can include, for example, virtual devices (e.g., one or more processors, memory, storage devices), a base operating system (e.g., an operating system kernel), a user-mode environment, applications, and so forth. A base operating system component provides various different low level system services to components in the guest, such as session management, program execution, input/output services, resource allocation, and so forth. The base operating system component can be a full operating system, or alternatively only a portion of a full operating system (e.g., the base operating system component may be a very small component if the guest shares most of the operating system with the host (in particular, the kernel)). The user-mode environment component provides a runtime environment for applications in the guest (e.g., a Java Runtime Environment, a .NET framework, and so forth). The application component is an application that is desired (e.g., by a user, administrator, other program, etc.) to be run in the guest (e.g., a web service, a calculation engine, etc.).

One type of guest that a guest 120 can be implemented as is referred to as a process container. For a process container, the application processes within the guest run as if they were operating on their own individual system (e.g., computing device), which is accomplished using namespace isolation. The host 102 implements namespace isolation. Namespace isolation provides processes in a guest a composed view consisting of the shared parts of the host 102 and the isolated parts of the host that are specific to each container such as filesystem, configuration, network, and so forth.

Another type of guest that a guest 120 can be implemented as is referred to as a virtualized container. For a virtualized container, the virtualized container is run in a lightweight virtual machine that, rather than having specific host physical memory 104 assigned to the virtual machine, has virtual address backed memory pages. Thus, the memory pages assigned to the virtual machine can be swapped out to a page file. The use of a lightweight virtual machine provides additional security and isolation between processes running in a guest. Thus, whereas process containers use process isolation or silo-based process isolation to achieve their containment, virtualized containers use virtual machine based protection to achieve a higher level of isolation beyond what a normal process boundary can provide. A guest may also be run in a virtual machine using host physical memory 104, and the techniques discussed used with the virtual machine. Such a virtual machine using physical memory allows for higher isolation, e.g., in situations where the use of virtual memory for the virtual machine is not desired because of performance or security concerns.

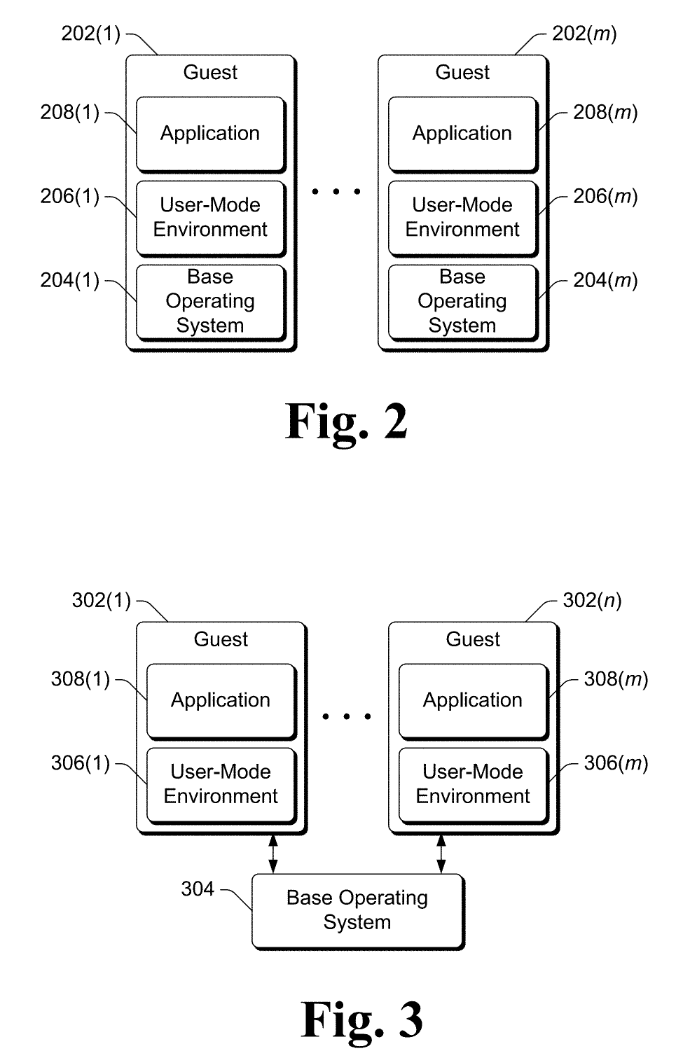

FIG. 2 illustrates multiple (m) example guests 202(1), . . . , 202(m). Each guest 202 includes multiple components illustrated as a base operating system (e.g., an operating system kernel) 204, a user-mode environment 206, and an application 208. Although a single application 208 is illustrated in each of the guests 202, it should be noted that a guest 202 can include multiple applications. Each guest 202 can include the same application 208, or alternatively different guests 202 can include different applications. Similarly, each guest 202 can include the same base operating system 204 and the same user-mode environment 206, or alternatively different guests 202 can include different base operating systems and/or different user-mode environments. One or more of the guests 202 can also optionally include various additional components, such as various different virtual devices (e.g., processors, memory, storage devices, and so forth).

The different components of the guests 202 are also referred to as being at different layers or levels. In the illustrated example of FIG. 2, the base operating system 204 is at the lowest layer or level, the user-mode environment 206 is at the next lowest layer or level, and the application 208 is at the highest layer or level. The component at a particular layer is started by or launched from a lower layer (typically the closest lower layer). For example, the user-mode environment 206 is started or launched by the base operating system 204, and the application 208 is started or launched by the user-mode environment 206. These layers or levels typically form a dependency hierarchy (e.g., an application depends on a specific version of a runtime environment (a user-mode environment), and the runtime environment depends on a specific base operating system)—it is usually not possible to replace a lower layer with a different version without invalidating the upper layers.

It should be noted that although the separation of components into base operating system, user-mode environment, and application components is one approach, guests can include a variety of layers. For example, the user-mode environment itself can be constructed from multiple layers. It should also be noted that one characteristic of the layers is that layers at a lower level are typically more generic (e.g., the base operating system), and layers at a higher level are typically more specialized (e.g., the specific application).

FIG. 3 illustrates multiple (n) example guests 302(1), . . . , 302(n). The guests 302 include user-mode environments 306 and applications 308, analogous to the user-mode environments 206 and applications 208 in the example of FIG. 2. However, in the example shown in FIG. 3 a base operating system 304 (e.g., an operating system kernel) is shared by the guests 302. Thus, rather than the base operating system being included as part of each container as illustrated in the example of FIG. 2, a single base operating system is shared by the multiple guests in the example of FIG. 3.

Although a single application 308 is illustrated in each of the containers 302, it should be noted that a guest 302 can include multiple applications. Each guest 302 can include the same application 308, or alternatively different guests 302 can include different applications. Similarly, each guest 302 can include the same user-mode environment 306, or alternatively different guests 302 can include different user-mode environments. One or more of the guests 302 can also optionally include various additional components.

Similar to the discussion of FIG. 2, the different components of the guests 302 are also referred to as being at different layers or levels. In the illustrated example of FIG. 3, the user-mode environment 306 is at the lowest layer or level and the application 308 is at the highest layer or level. The component at a particular layer is started by or launched from a lower layer (typically the closest lower layer). For example, the application 308 is started or launched by the user-mode environment 306. The user-mode environment 306 of each guest 302 is started or launched by the base operating system 304. Although not part of the guests 302, the base operating system can also be referred to as being at a lower layer or level than the user-mode environments 306.

Returning to FIG. 1, the host 102 includes a memory manager module 118 that manages the host physical memory 104. In one or more embodiments, the host memory manager module 118 manages the host physical memory 104 using virtual memory and paging. Virtual memory refers to having a virtual address space for different programs running in the system 100 (e.g., different guests 120), and different portions of that virtual memory are mapped to various portions of the physical memory 104 at different times. For example, the memory manager module 118 can assign a virtual address space to the guest 120 when the guest 120 is created. Paging refers to the memory manager module 118 organizing the physical and virtual memory into pages, which are a particular (e.g., fixed) size unit of data. The act of paging refers to reading data in units of pages from a backing file (e.g., stored on a hard drive or other storage device of the system 100) when the data is not in the host physical memory 104. The act of paging also refers to writing dirty (modified) data back in units of pages into the page file. The memory pages are thus also referred to as page file backed memory pages. Such virtual memory and paging techniques are well known to those skilled in the art.

The guest 120 and the host 102 (e.g., via the guest shared memory manager module 132 and the host shared memory manager module 112, respectively) agree on a name and a size for the shared memory 124. The name for (which is an identifier of) the shared memory 124 allows the shared memory 124 to be identified by the guest 120 and the host 102, and allows different shared memories in the system 100 to be distinguished from one another. The name of the shared memory 124 can optionally be a file name that is within a namespace associated with shared memory rather than files.

The host shared memory manager module 112 allocates or assigns a memory space to be used as shared memory 124. The host shared memory manager module 112 provides an indication of this allocated or assigned memory space to the guest 120. Both the guest 120 and the host 102 maintain a mapping to the shared memory 124, allowing both the guest and the host to access the shared memory 124.

Various access controls can be applied to the shared memory 124. These access controls can be applied when the memory space for the shared memory 124 is allocated, or alternatively at other times. For example, the access controls can be applied by the host shared memory manager module 112 after the shared memory 124 is created. The access controls can define various access rights for various different entities (e.g., programs, processes, guest or host, etc.), such as read access and/or write access. The access controls can also define various restrictions and/or permissions on the shared memory 124, such as whether the shared memory 124 is executable (instructions stored in the shared memory can be executed), and so forth.

In one or more embodiments, the creation of the shared memory 124 is initiated by the guest 120. A program running in the guest 120 (also referred to as a guest program) invokes a method of an application programming interface (API) requesting to open a file. This API can be exposed by, for example, the operating system running the guest program (e.g., an operating system running in the guest 120). The request includes the name of the file (which is also a name for the shared memory to be created) and a desired size of the shared memory.

The guest shared memory manager module 132 communicates the request to open the file to the host shared memory manager module 112. The host shared memory manager module 112 knows that the request to open a file is actually a request to create shared memory. The host shared memory manager module 112 can know this in various manners, such as an indication that is included in the request (e.g., the namespace for the file is a namespace associated with shared memory). Alternatively, the host shared memory manager module 112 can be a module dedicated to only creating shared memory (as opposed to other types of files), and thus a request provided to the host shared memory manager module 112 is inherently a request to create shared memory.

The host 102 creates the shared memory 124 by allocating or assigning an address space to be the shared memory 124. This shared memory 124 is also referred to as a memory mapped file. The amount of memory assigned or allocated is the size indicated by the guest program in the request to open the file. The host shared memory manager module 112 returns an identifier of the shared memory 124 to the guest shared memory manager module 132. This identifier can be, for example, a file handle or other identifier that allows different shared memories to be distinguished from one another.

The guest shared memory manager module 132 obtains, from the host 102, the indication of the address space that is the shared memory 124. The indication can be returned with the file handle, or alternatively additional communications can be had between the guest shared memory manager module 132 and the host shared memory manager module 112 to communicate the indication of the address space.

Alternatively, the creation of the shared memory 124 is initiated by the host 102 rather than the guest 120. In such situations, a program running in the host 102 (also referred to as a host program) invokes a method of an API requesting to open a file. This API can be exposed by, for example, the operating system running the host program (e.g., an operating system running in the host 102). The request includes the name of the file (which is also a name for the shared memory to be created) and a desired size of the shared memory. This shared memory 124 is also referred to as a memory mapped file, regardless of whether the host 102 or the guest 120 initiates the creation of the shared memory 124.

The host 102 creates the shared memory 124 by allocating or assigning an address space to be the shared memory 124. The amount of memory assigned or allocated is the size indicated by the host program in the request to open the file. The host shared memory manager module provides an identifier of the shared memory 124 to the guest shared memory manager module 132. This identifier can be, for example, a file handle or other identifier that allows different shared memories to be distinguished from one another.

The guest shared memory manager module 132 obtains, from the host 102, the indication of the address space that is the shared memory 124. The indication can be returned with the file handle, or alternatively additional communications can be had between the guest shared memory manager module 132 and the host shared memory manager module 112 to communicate the indication of the address space.

In one or more embodiments, the guest 120 is a virtual address (VA) backed virtual machine. Such situations support host side pageability because the guest physical memory 122 is actually a virtual address range, and allow the shared memory 124 to be pageable memory. Alternatively, the guest 120 can be a physically backed (rather than VA backed) virtual machine. In such situations, the shared memory 124 and the guest physical memory 122 can be locked (e.g., allocated to a process and locked in physical memory), and thus maintained in the physical memory rather than being paged out. The host shared memory manager module 112 or a hypervisor of the system 100 can then map the physical memory pages of the shared memory 124 into guest physical memory pages that can be accessed by programs running in the guest 120.

In one or more embodiments, the shared memory 124 is included as part of the guest physical memory 122. In such embodiments, the shared memory 124 is counted against any allocation of memory to the guest 120. For example, if the guest 120 is allocated 1 gigabyte (GB) of memory and the shared memory 124 is 100 megabytes (MBs), then the 100 MBs of the shared memory 124 is part of the 1 GB allocated to the guest 120.

Alternatively, the shared memory 124 can be separate from the guest physical memory 122. In such embodiments, the shared memory 124 is not counted against any allocation of memory to the guest 120. For example, if the guest 120 is allocated 1 GB of memory and the shared memory 124 is 100 MBs, then the 100 MBs of the shared memory 124 is in addition to the 1 GB allocated to the guest 120. In such embodiments, a limit can be imposed on the shared memory 124. For example, the host 102 may impose a limit of 500 MBs of shared memory in the system 100, preventing too much shared memory from being allocated in the system 100 and adversely affecting memory management and/or other performance of the system 100.

Sharing physical memory between a host and a guest VM can have many performance and density advantages. Sharing arbitrary non-file data can be useful, improving performance of the system 100. One example usage of such sharing is graphics surfaces (e.g., for windows). Instead of copying contents of graphics surfaces rendered by a guest VM, it can be more efficient to directly share those surfaces with the host such that they can be directly rendered on the graphics hardware on the host.

The following is an example implementation of the shared memory between host and guest on a computing device. The guest and the host agree on a name for shared memory and then both the guest and the host create or open the shared memory and map it into its address space. An API can be invoked by the guest that maps the name specified by the guest to a special path by a shared memory filesystem driver of the guest, and the counterpart to the shared memory filesystem driver on the host maps the path to a host-side, per-guest path and creates a file- or pagefile-backed section associated with the “file”. On the guest side, the API creates a section on top of the file handle it just opened and the memory manager queries the file system for physical memory extents which is forwarded to the host. The host maps the host-side section into the host process address space and asks the guest memory manager to map the virtual address range to a new guest physical address space, and the guest physical address extents are returned to the guest.

The guest can initiate section creation by calling a CreateVmSharedMemory API. In response, the CreateVmSharedMemory API calls a CreateFile API specifying a known (e.g., to the guest and the host) shared memory namespace. The purpose of this call is to open a handle to the host and allow handle lifetime using the file system. The CreateVmSharedMemory API can use various parameters, including desired access (e.g., indicating to translate requests for “page read only” to “file read data”, requests for “page read write” to “file write data”, and requests for “page execute read only” or “page execute read write” to read or write “file execute”). Various additional parameters can be included, such as a creation disposition (e.g., what action to take if the requested file has already been opened), creation options, the size of the shared memory to create, and so forth.

The host issues the create file request to a server module of the host (e.g., the host shared memory manager module 112), and the server module notices that this is a special file (e.g., for shared memory) and processes the create file request internally (but does not issue a create to the file system). The server module creates a section object for the requested size to represent the memory space that will be the shared memory. The server module adds access controls to the section object (e.g., the same access rights that the security identifier of the user of the guest has).

The server module creates the section and assigns or allocates the memory space of the requested size to the section object, and assigns the section a name (e.g., that is the same as or based on the requested name provided by the guest). The server module allocates a file identifier for the requested file handle, maps the file identifier to the section handle, and returns an indication of successful file creation to the host and the CreateVmSharedMemory API. The CreateVmSharedMemory API then calls a CreateSection API, specifying the file handle returned by the CreateFile request to create a file-backed section. The requested section is created having the same section name as was assigned by the server module.

The host can issue a command to the server module to map the section in memory. The server module responds to the command by asking the memory manager for the guest to allocate a region of the guest physical address space for the section. The memory manager for the maps the shared memory to the guest physical address space, and an indication of the successful mapping is returned to the server module and the host.

On the host side, to open and access the shared memory section, a program invokes an OpenVmSharedMemorySectionMapping API, which in turn invokes an OpenSection API with the section name (the name of the shared memory). The OpenSection API returns the section handle, and the host maps the section into its own virtual address space.

On the guest side, the shared memory section can be closed at some point. The host invokes a CloseHandle API on the section handle, and eventually receives a close request for the file handle for the shared memory. The host waits for the memory manager to stop using the section, and issues a close request to the server module of the host. The server module instructs the memory manager of the guest to stop mapping the shared memory to the guest, in response to which the memory manager tears down the memory mapping, unmaps the shared memory, and closes the section object by closing the section handle.

On the host side, the shared memory is closed by invoking an Unmap API that unmaps the shared memory for the host. A Close API is then invoked to close the section handle.

Although reference is made to file names, it should be noted that using file names can allow pre-existing components of an operating system to be used to implement the techniques discussed herein. However, there need not be a file on the guest side that is opened or created—a name is assigned (e.g., made up by the guest) and sent to the host so that the name is mapped to a pagefile backed section namespace on the host, and arbitrary memory pages are mapped into the guest. The shared memory is mapped into the guest and can be referenced by a file descriptor (e.g., a file handle), and thus the shared memory is also referred to as a memory mapped file.

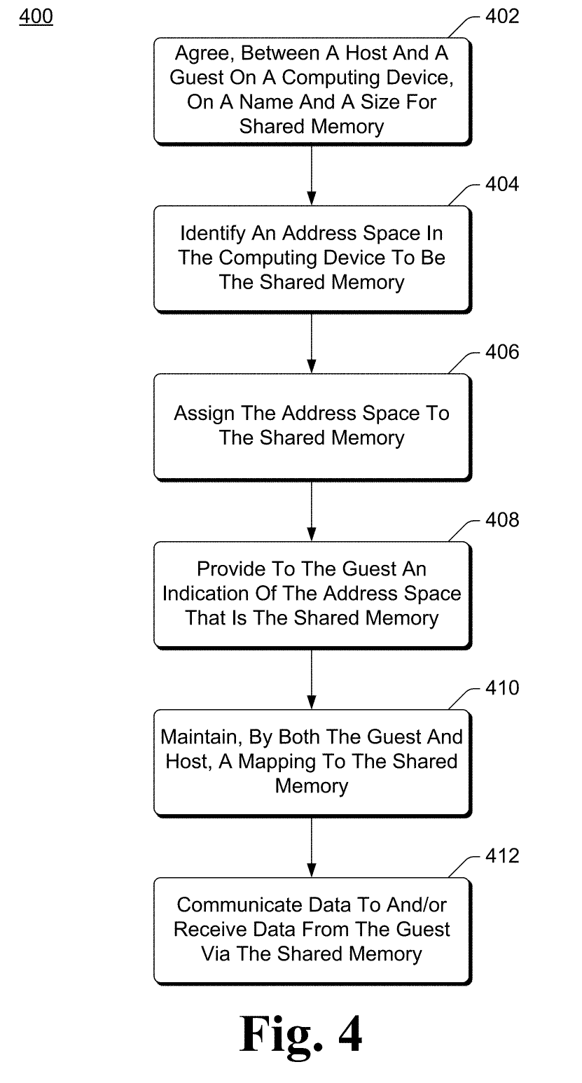

FIG. 4 is a flowchart illustrating an example process 400 for implementing the shared memory between host and guest on a computing device in accordance with one or more embodiments. Process 400 is carried out by a device, such as computing device implementing the system 100 of FIG. 1, and can be implemented in software, firmware, hardware, or combinations thereof. Process 400 is shown as a set of acts and is not limited to the order shown for performing the operations of the various acts. Process 400 is an example process for implementing the shared memory between host and guest on a computing device; additional discussions of implementing the shared memory between host and guest on a computing device are included herein with reference to different figures.

In process 400, an agreement on a name and a size of shared memory is made between a host and a guest on a computing device (act 402). The agreement can be reached in various manners, such as the guest providing a name and size to the host and the host allocating the shared memory in response to the name and size satisfying various rules or criteria (e.g., the requested name being within an acceptable namespace, the size being within a size threshold or limit for shared memory). Additionally or alternatively, the host can provide the name and/or size for the shared memory.

An address space in the computing device to be the shared memory is identified (act 404). The address space can be identified by being assigned or allocated by a memory manager (e.g., running in the host) using any of a variety of public and/or proprietary techniques.

The identified address space is assigned or allocated to the shared memory (406). By assigning or allocating the identified address space to the shared memory, the address space will not be used by other guests or processes in the system.

An indication of the address space that is the shared memory is provided to the guest (act 408). The indication can be provided at various times as discussed above, such as in response to the guest's request for a file name for shared memory, or at another time.

Both the guest and the host maintain a mapping to the shared memory (act 410). This mapping allows both the guest and the host to access the shared memory.

Data is communicated to and/or received from the guest via the shared memory (act 412). Any of a variety of data can be communicated to and/or received from the guest, such as data to be displayed, data input by a user, data to be transmitted to another device or system, data received from another device or system, and so forth.

Although particular functionality is discussed herein with reference to particular modules, it should be noted that the functionality of individual modules discussed herein can be separated into multiple modules, and/or at least some functionality of multiple modules can be combined into a single module. Additionally, a particular module discussed herein as performing an action includes that particular module itself performing the action, or alternatively that particular module invoking or otherwise accessing another component or module that performs the action (or performs the action in conjunction with that particular module). Thus, a particular module performing an action includes that particular module itself performing the action and/or another module invoked or otherwise accessed by that particular module performing the action.

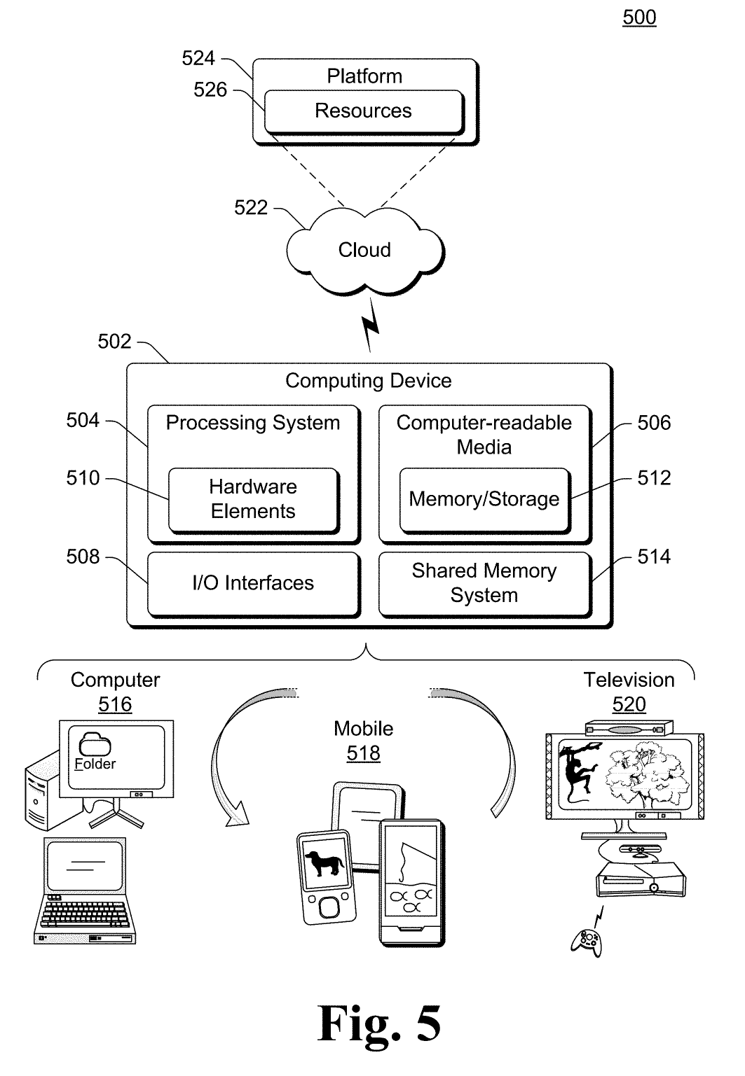

FIG. 5 illustrates an example system generally at 500 that includes an example computing device 502 that is representative of one or more systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O Interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Resistive RAM (ReRAM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

The one or more input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone (e.g., for voice inputs), a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

The computing device 502 also includes a shared memory system 514. The shared memory system 514 provides various shared memory functionality, such as a guest shared memory manager module and/or host shared memory manager module as discussed above.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “computer-readable signal media.”

“Computer-readable storage media” refers to media and/or devices that enable persistent storage of information and/or storage that is tangible, in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” refers to a signal-bearing medium that is configured to transmit instructions to the hardware of the computing device 502, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, the hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one or more embodiments, the central computing device may be a cloud of one or more server computers that are connected to the multiple devices through a network, the Internet, or other data communication link.

In one or more embodiments, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one or more embodiments, a class of target devices is created and experiences are tailored to the generic class of devices. A class of devices may be defined by physical features, types of usage, or other common characteristics of the devices.

In various implementations, the computing device 502 may assume a variety of different configurations, such as for computer 516, mobile 518, and television 520 uses. Each of these configurations includes devices that may have generally different constructs and capabilities, and thus the computing device 502 may be configured according to one or more of the different device classes. For instance, the computing device 502 may be implemented as the computer 516 class of a device that includes a personal computer, desktop computer, a multi-screen computer, laptop computer, netbook, and so on.

The computing device 502 may also be implemented as the mobile 518 class of device that includes mobile devices, such as a mobile phone, portable music player, portable gaming device, a tablet computer, a multi-screen computer, and so on. The computing device 502 may also be implemented as the television 520 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This functionality may also be implemented all or in part through use of a distributed system, such as over a “cloud” 522 via a platform 524 as described below.

The cloud 522 includes and/or is representative of a platform 524 for resources 526. The platform 524 abstracts underlying functionality of hardware (e.g., servers) and software resources of the cloud 522. The resources 526 may include applications and/or data that can be utilized while computer processing is executed on servers that are remote from the computing device 502. Resources 526 can also include services provided over the Internet and/or through a subscriber network, such as a cellular or Wi-Fi network.

The platform 524 may abstract resources and functions to connect the computing device 502 with other computing devices. The platform 524 may also serve to abstract scaling of resources to provide a corresponding level of scale to encountered demand for the resources 526 that are implemented via the platform 524. Accordingly, in an interconnected device embodiment, implementation of functionality described herein may be distributed throughout the system 500. For example, the functionality may be implemented in part on the computing device 502 as well as via the platform 524 that abstracts the functionality of the cloud 522.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a host on a computing device, the method comprising: agreeing, with a guest on the computing device, on a name and a size for a shared memory, the host having an associated host memory on the computing device and the guest having an associated guest memory on the computing device; identifying an address space in the computing device to be the shared memory, the address space having at least the agreed upon size; allocating or assigning the address space to the shared memory; providing to the guest an indication of the address space that is the shared memory; and communicating data to and/or receiving data from the guest via the shared memory.

Alternatively or in addition to any of the methods or devices described herein, any one or combination of: the communicating comprising receiving data from a Web browser program running in the guest, the method further comprising displaying a user interface for the Web browser program using the received data; the method further comprising imposing one or more access restrictions on the shared memory, the one or more access restrictions including read access restrictions and/or write access restrictions; the imposing one or more access restrictions on the shared memory comprising giving the guest write only access to the shared memory and giving the host read only access to the shared memory; the shared memory being part of the guest memory; the shared memory being an additional address space accessible to the guest in addition to the memory space of the guest memory; the host comprising a host operating system on the computing device, and the guest comprising a process container or a virtualized container.

A method implemented in a guest on a computing device, the method comprising: agreeing, with a host on the computing device, on a name and a size for a shared memory, the host having an associated host memory on the computing device and the guest having an associated guest memory on the computing device; receiving, from the host, an indication of an address space in the computing device that is the shared memory, the address space having at least the agreed upon size; and communicating data to and/or receiving data from the guest via the shared memory.

Alternatively or in addition to any of the methods or devices described herein, any one or combination of: the communicating comprising rendering a surface to be displayed into the shared memory to allow the guest to display the surface as part of a user interface of the computing device; one or more access restrictions being imposed on the shared memory, the one or more access restrictions including read access restrictions and/or write access restrictions; the guest being given write only access to the shared memory and the host being given read only access to the shared memory; the shared memory being part of the guest memory; the shared memory being an additional address space accessible to the guest in addition to the memory space of the guest memory; the host comprising a host operating system on the computing device, and the guest comprising a process container or a virtualized container.

A computing device comprising: a processor; and a computer-readable storage medium having stored thereon multiple instructions that implement a host on the computing device and that, responsive to execution by the processor, cause the one or more processors to: agree, with a guest on the computing device, on a name and a size for a shared memory, the host having an associated host memory on the computing device and the guest having an associated guest memory on the computing device; identify an address space in the computing device to be the shared memory, the address space having at least the agreed upon size; allocate or assign the address space to the shared memory; provide to the guest an indication of the address space that is the shared memory; and communicate data to and/or receive data from the guest via the shared memory.

Alternatively or in addition to any of the methods or devices described herein, any one or combination of: the multiple instructions further causing the processor to impose access restrictions on the shared memory, the access restrictions including giving the guest write only access to the shared memory; the access restrictions including giving the host read only access to the shared memory; the shared memory being part of the guest memory; the shared memory being an additional address space accessible to the guest in addition to the memory space of the guest memory; the host comprising a host operating system on the computing device, and the guest comprising a process container or a virtualized container on the computing device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method implemented in a host on a computing device, the method comprising:
agreeing, with a guest on the computing device, on a name and a size for a shared memory, the host having an associated host memory on the computing device and the guest having an associated guest memory on the computing device;
identifying an address space in the computing device to be the shared memory, the address space having at least the agreed upon size;
allocating or assigning the address space to the shared memory;
providing to the guest an indication of the address space that is the shared memory; and
communicating data to and/or receiving data from the guest via the shared memory.

2. The method as recited in claim 1, the communicating comprising receiving data from a Web browser program running in the guest, the method further comprising displaying a user interface for the Web browser program using the received data.

3. The method as recited in claim 1, further comprising imposing one or more access restrictions on the shared memory, the one or more access restrictions including read access restrictions and/or write access restrictions.

4. The method as recited in claim 3, the imposing one or more access restrictions on the shared memory comprising giving the guest write only access to the shared memory and giving the host read only access to the shared memory.

5. The method as recited in claim 1, the shared memory being part of the guest memory.

6. The method as recited in claim 1, the shared memory being an additional address space accessible to the guest in addition to the memory space of the guest memory.

7. The method as recited in claim 1, the host comprising a host operating system on the computing device, and the guest comprising a process container or a virtualized container.

8. A method implemented in a guest on a computing device, the method comprising:
agreeing, with a host on the computing device, on a name and a size for a shared memory, the host having an associated host memory on the computing device and the guest having an associated guest memory on the computing device;
receiving, from the host, an indication of an address space in the computing device that is the shared memory, the address space having at least the agreed upon size; and
communicating data to and/or receiving data from the guest via the shared memory.

9. The method as recited in claim 8, the communicating comprising rendering a surface to be displayed into the shared memory to allow the guest to display the surface as part of a user interface of the computing device.

10. The method as recited in claim 8, one or more access restrictions being imposed on the shared memory, the one or more access restrictions including read access restrictions and/or write access restrictions.

11. The method as recited in 10, the guest being given write only access to the shared memory and the host being given read only access to the shared memory.

12. The method as recited in claim 8, the shared memory being part of the guest memory.

13. The method as recited in claim 8, the shared memory being an additional address space accessible to the guest in addition to the memory space of the guest memory.

14. The method as recited in claim 8, the host comprising a host operating system on the computing device, and the guest comprising a process container or a virtualized container.

15. A computing device comprising:
a processor; and
a computer-readable storage medium having stored thereon multiple instructions that implement a host on the computing device and that, responsive to execution by the processor, cause the one or more processors to:
agree, with a guest on the computing device, on a name and a size for a shared memory, the host having an associated host memory on the computing device and the guest having an associated guest memory on the computing device;
identify an address space in the computing device to be the shared memory, the address space having at least the agreed upon size;
allocate or assign the address space to the shared memory;
provide to the guest an indication of the address space that is the shared memory; and
communicate data to and/or receive data from the guest via the shared memory.

16. The computing device as recited in claim 15, the multiple instructions further causing the processor to impose access restrictions on the shared memory, the access restrictions including giving the guest write only access to the shared memory.

17. The computing device as recited in claim 16, the access restrictions including giving the host read only access to the shared memory.

18. The computing device as recited in claim 15, the shared memory being part of the guest memory.

19. The computing device as recited in claim 15, the shared memory being an additional address space accessible to the guest in addition to the memory space of the guest memory.

20. The computing device as recited in claim 15, the host comprising a host operating system on the computing device, and the guest comprising a process container or a virtualized container on the computing device.
